(19) United States
(12) Patent Application Publication
(10) Pub. No.: US 2001/0005863 A1
(43) Pub. Date: Jun. 28, 2001

(54) System for performing radiative transfer computations

(76) Inventors: Franz Schreier, Planegg (DE); Birger Schimpf, Gilching (DE)

Correspondence Address: BROWDY AND NEIMARK, P.L.L.C., 419 Seventh Street, N.W., Washington, DC, 20004, US

(21) Appl. No.: 09/734,930

(22) Filed: Dec. 13, 2000

(30) Foreign Application Priority Data
Dec. 13, 1999 (EP) 99 124 735.4

(51) Int. Cl. G06F 9/00; G06F 9/46; G06F 15/163

(52) U.S. Cl. 709/311

(57) ABSTRACT

The method in accordance with the invention for implementing radiative transfer computations is handled via a graphical user interface independently of the operating system by means of a common gateway interface CGI between a web browser at a workplace computer (1) of the user (2) and a web server computer (3). For this purpose the parameters are queried on a HTML form at the workplace computer of the user and sent to a web server computer on which the radiative transfer computation program e.g. FASCODE or MODTRAN is then executed with these parameter inputs. The computed spectra as well as the standard output file are sent back to the workplace computer of the user where they are presented on an automatically generated HTML page. The method in accordance with the invention can be used for implementing radiative transfer computations e.g. in meteorological, climate and ozone research and for non intrusive spectroscopic measurement for investigating gaseous media.

### FIELD OF THE INVENTION

The invention relates to a system for performing radiative transfer computations for which the conditions influencing the radiative transfer are specified by a user and the radiative transfer code is then executed using the user's specifications as input parameters.

### BACKGROUND OF THE INVENTION

Radiative transfer computation programs are a tool important to many fields of basic research, e.g. in meteorology and in climate and ozone research, as well as in applied research, especially in this respect in non intrusive spectroscopic systems of measurement for investigating gaseous media, e.g. jet engine exhaust, stack emissions and in remote sensing. In addition to a variety of programs tailored to concrete, closely defined applications a few programs also exist for general use.

The radiative transfer computation programs best known and widely in use for the millimeter, infrared and ultraviolet spectral range as well as for the visible spectral range are the LOWTRAN or MODTRAN and FASCODE programs developed years ago at the Phillips Laboratory (formerly Air Force Geophysics Laboratory, Mass., USA). LOWTRAN and MODTRAN involve a low-resolution band model. MODTRAN is a further development of LOWTRAN and totally compatible with LOWTRAN; in particular it is operable in the LOWTRAN mode by selecting a corresponding option (U.S. Pat. Nos. 5,075,856 and 5,315,513).

FASCODE is a high-resolution line-by-line model (S. A. Clough et al.: FASCODE3: Spectral Simulation. In J. Lenoble ad J. F. Geleyn, Editors, IRS'88: Current Problems in Atmospheric Radiation. A. Deepak Publ., 1988) The line-by-line model GENLN2 has also found a wide distribution.

Radiative transfer is determined by absorption, emission and scattering processes of light on atoms, molecules and aerosols. Mathematically this is described by the radiative transfer equations, more particularly by the Beer-Bouguer-Lambert law and the Schwarzschild equation, scattering being irrelevant for the further discussion and is thus neglected in the following:

$$\begin{matrix}τ ( v , {s}_{0} , s ) = exp ( - {\int }_{{s}_{0}}^{s} ⅆ {s}^{′} k ( v , p ( {s}^{′} ) , T ( {s}^{′} ) ) n ( {s}^{′} ) ) & ( 1 ) \\ I ( v , s ) = {I}_{0} ( v ) τ ( v ; {s}_{0} , s ) + {\int }_{{s}_{0}}^{s} ⅆ {s}^{′} B ( v , T ( {s}^{′} ) ) \partial τ \frac{( v ; {s}^{′} , s )}{\partial {s}^{′}} & ( 2 )\end{matrix}$$

where τ and I are the transmission or radiance (intensity) as a function of the wave number ν, k the absorption coefficient, B(ν,T) the Planck's function of the temperature T, and s′ the path coordinate along the line of sight to the observer at point s. Solving these (integral) equations is the central task of radiative transfer computation programs.

For performing a radiative transfer computation the user needs to specify all conditions influencing the radiative transfer. Due to PASCODE or MODTRAN being highly flexible this necessitates a plurality of inputs, whereby it is to be noted that FASCODE or MODTRAN have been mainly developed for atmospheric applications. However, it is just as possible to compute with these programs the radiative transfer in any other gaseous media.

The inputs relate to, among other things, the observation geometry, i.e. e.g. the position of the observer, the viewing direction and the like.

Inputs are also required as regards characterizing the gaseous medium or the atmosphere, i.e. temperature, pressure and composition (gas concentrations and/or aerosol densities or the like). In the general case of an inhomogeneous medium these parameters are to be specified as a function of the location and thus along the path. For straight-forward atmospheric applications FASCODE or MODTRAN offer the possibility of specifying the atmospheric conditions by selecting a standard atmosphere model (e.g. midlatitude summer or winter): the corresponding data (pressure, temperature, densities, etc.) are implemented internally in FASCODE or MODTRAN.

In atmospheric applications in which the user wishes to use his own data, e.g. measured pressure, temperature, density profiles, for the radiative transport computation or for other radiative transport computations in other gaseous media, e.g. in an exhaust jet, the user needs to enter this data into the FASCODE or MODTRAN input file.

In this context reference is made to FIG. 1 illustrating an example of a FASCODE input file. This example describes a slant path from 12 km to an altitude of 50 km at an angle of 30°. For ClO (molecule No. 18) user data is employed; for all other molecules as well as pressure and temperature a US Standard atmosphere profile (model No. 6) is used. Three different radiance spectra are computed: monochromatic as well as convolved with a Gauβ- and sinc function 0.001 cm⁻¹ wide. The spectra produced by the two convolutions are buffered on temporary files TAPE82 and TAPE83; in conclusion all 3 radiance spectra are written on the files TAPE61, TAPE62 and TAPE63.

The inputs for implementing a radiative transfer computation relate also to a background specification, more particularly the temperature and emissivity thereof. Inputs as to the spectral range (lower and upper limit in wave numbers, cm⁻¹) are also needed.

Also to be input is an instrument(s) characterization. FASCODE offers the possibility of degrading the resolution of the initially computed high-resolution, so-called monochromatic spectrum by convolution with various response functions to take into account the instrumental effects, e.g. of a Fourier transform spectrometer in modelling a spectrum. Analogously spectrally dependent sensitivities can be taken into account by multiplication with various filter functions. Corresponding parts of the program can be called by the user by additional optional inputs in the input file.

In addition, the user can select various further options influencing the assumptions or models forming the physical basis and to set or change the requirements on the numerical approximations or procedures.

These known methods of implementation have serious disadvantages. All of the inputs influencing the radiative transfer computation need to be entered in a non-commented and non-self explanatory formatized input file which is read FORTRAN formatized by FASCODE or MODTRAN. Since FASCODE or MODTRAN reads the user inputs from a formatized input file all input parameters need to be set even when the user wishes to individually set only a few parameters, e.g. the limits of the desired spectral range, the geometry of the beam path and the number of the desired model atmosphere and otherwise accepts the default settings.

This is particularly a severe problem for users new to these radiative transfer computation programs or only occasionally making use thereof, as is evident from FIG. 2 illustrating an example of a simple FASCODE input file. The dollar signs in line 1 as well as the percentage signs in the last line are control characters, the remainder of the first line and line 6 is a comment. In line 2 various switches are set, in line 3 the spectral range to be computed is specified, lines 4 and 5 serve to define the atmospheric conditions: a horizontal path (switch 1 in line 4) of 1 km in a model atmosphere #2 (midlatitude summer) with 7 IR-active molecules and a CO₂ mixing ratio of 330 ppm.

Only computation of the monochromatic transmission is required (but not the radiance, switch 5 in line 2 is 0) and this (stored internally in binary format on a temporary file TAPE12) to be output on a formatted (ASCII) file TAPE61.

FASCODE requires in addition a spectroscopic line parameter data base, this being as standard the HITRAN data base available as a formatted ASCII file on CD-ROM (approx. 100 megabyte). FASCODE reads this file however in its own binary format, i.e. HITRAN needs to be reformatted before the actual radiative transport computation is done in a separate preprocessor program.

It is often desired, however, to simultaneously make use of spectroscopic data from other data bases, e.g. for simulating the IR radiation of a hot exhaust jet the H₂O, CO₂, CO data from the more recent HITEMP data base and data of other molecules from HITRAN which is not possible without complicated preprocessing in current FASCODE implementation.

Implementing FASCODE or MODTRAN requires all files needed in the various phases of the program sequence to be present in the same directory. Although this is reasonable for job-specific files, e.g. for input and output files as well as for files including the computed spectra, it is not useful for files independent of the job, such as e.g. the HITRAN data base. In particular because of its size copying the HITRAN data base in every working directory is not useful. UNIX offers the possibility of a link in the file system.

Referring now to FIG. 3 there is illustrated a shell script which would control the FASCODE radiative transfer computation as specified in FIG. 2 when run under UNIX, assuming that the user calls this shell script in the working directory. The HITRAN data base is linked (copied) in this directory; the input file entered by the user under the name “horiz.in” (cf FIG. 2) likewise being linked as TAPES. The executable FASCODE program is then called and the input and output files redirected. Finally the output files are renamed to “useful” names and temporary files removed.

In addition to the input files required by FASCODE (user input file and spectral data base) and the files generated by FASCODE (“standard output” and one file for each spectrum computed) FASCODE generates a series of temporary files for buffering. In the current UNIX implementation these files are not removed on end of job and thus need to be removed by the user.

Historically, due to the development of FASCODE or MODTRAN on mainframes, the names of all files (input, output, temporary files) are fixed. These names are composed of “TAPE” followed by a single or double digit integer number assigning the number of an input/output unit (Fortran logical unit) to the file. In addition to TAPE5—input file with user inputs and TAPE6—output file (“standard output”) these are for FASCODE:

TAPE3—binary version of the (HITRAN) spectral parameter data base, TAPE9, TAPE10, TAPE11, TAPE12, TAPE14, TAPE20—temporary files. Each computed spectrum is written on a separate file named TAPEnn where nn is a integer number to be specified by the user in the input file, noting that input/output units already in use are no longer available.

MODTRAN writes all computed spectra into two files: TAPE7 and TAPE8.

It is obviously advantageous to steer the error prone collection of input parameters via a graphical user interface, GUI, and to automatically generate the input file, and eventually the script to link the files required by FASCODE or MODTRAN. Corresponding programs PcLnWin for FASCODE and PCModWin for MODTRAN have been developed by ONTAR Co. (http://www.ontar.com/) which still have a few serious disadvantages, however. Operation is only possible for PCs running under DOS/Windows and no GUI is available for other operating systems (UNIX/LINUX,MAC etc).

These programs have to be installed on every computer, which takes up an enormous amount of time and is far from trivial. Apart from this the HITRAN data base (approx. 100 MB) needs to be made available on every computer, additionally requiring the data base to be converted from ASCII into the binary format. Hard disk space is needed on every computer for the executable program (with extension “.exe”). The requirements on the CPU, RAM and on the Math coprocessor are also considerable. In addition, the quick look and graphics facilities as well as the accuracy of the ASCII output files are limited.

Many of the arguments discussed with respect to FASCODE and MODTRAN are equally valid for the newer radiative transfer computer program GENLN2. Although documentation is significantly more detailed and understandable, setting up a job is still a heavy burden for new or occasional users.

### SUMMARY OF THE INVENTION

It is thus the object of the invention in avoiding the disadvantages as cited above as best possible to provide a method and a system supporting users of radiative transfer computations which enables to execute programs such as FASCODE, MODTRAN or GENLN2 independently of the operating system and which also helps new or occasional users through a simple and intuitive guidance by means of a graphical user interface.

In accordance with the invention relating to a system of the aforementioned kind, this object is achieved by the method comprising the steps:

handling the method via a graphical user interface by means of a common gateway interface CGI between a web browser at a workplace computer of the user and a web server computer,

specifying all parameters defining the radiative transfer computation in a sequence of automatically generated forms by the user on the web browser of his workplace computer,

generating the input file needed for the radiative transfer computation program in a format requested by the radiative transfer computation program in the web server computer as specified by the user,

calling via a system command the radiative transfer computation program on the web server computer or, where necessary, on a separate compute server in linking any additionally required files stored in the web server computer to the radiative transfer computation program and, finally,

returning from the web server computer the results computed therein to the workplace computer of the user where they are made available on an automatically generated document.

A common gateway interface CGI enables a WWW browser, e.g. Netscape Navigator or Internet Explorer to execute programs at or call data from a WWW server (http server, e.g. Apache), browser and server computer communicating via HTML documents, more particularly, forms. In the method in accordance with the invention for a system for radiative transfer computations the user inputs on a HTML form are polled and sent to a server computer on which the steps of the radiative transfer computation program are executed, and after execution the computed spectra as well as the standard output file returned to the client computer at the user where they are presented on an automatically generated HTML page. The web browser on the computer of the user thus serves as a graphic interface independent of the operating system for the radiative transfer computation program installed in the web server computer.

Advantageous further embodiments of the system in accordance with the invention read from the sub-claims. The invention and advantageous aspects thereof will now be detailed with reference to the drawings in which:

### BRIEF DESCRIPTION OF THE DRAWINGS

FIG. 1 is a printout of part of a FASCODE input file already explained as an example,

FIG. 2 is likewise a printout of part of a simple FASCODE input file already explained as an example,

FIG. 3 is a printout of a simple shell script already explained as an example for controlling a FASCODE computation,

FIG. 4 is a single-line diagram illustrating a CGI program,

FIG. 5 is an illustration of the starting page of a web interface for radiative transfer computation programs,

FIG. 6 is an illustration of the second page of a web interface for radiative transfer computation programs,

FIG. 7 is a schematic illustration of the sequence in implementing a radiative transfer computation with the aid of a web interface, and

FIG. 8 is an illustration of the results document of a web interface for radiative transfer computation programs.

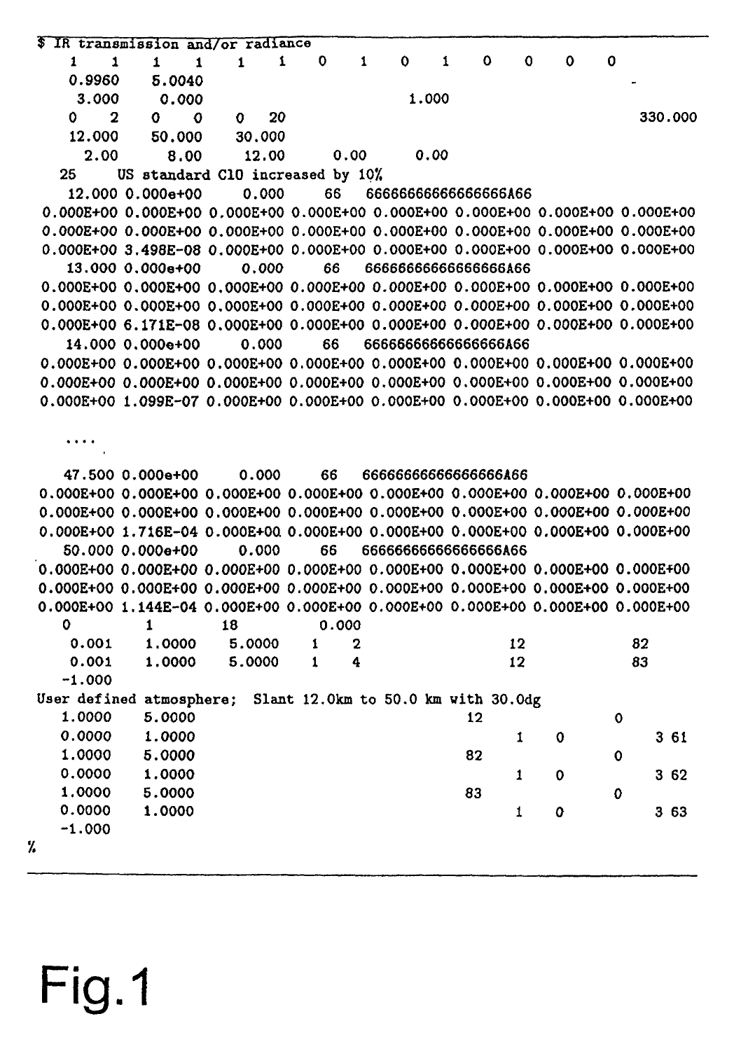

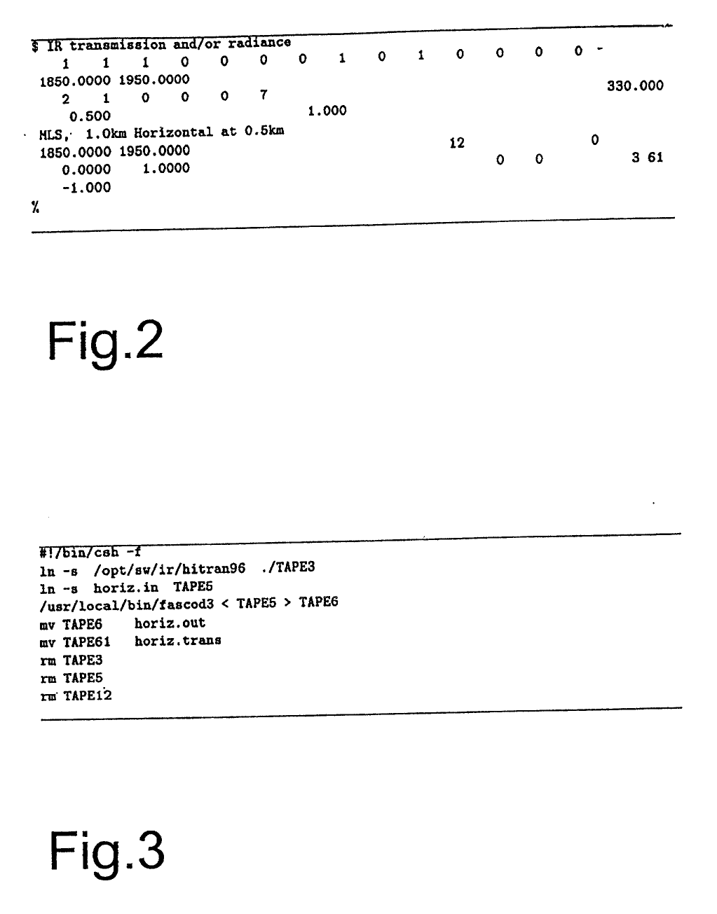

### DETAILED DESCRIPTION

CGI programs can be written in any programming language. However, since programs in languages such as C, FORTRAN or PASCAL first need to be compiled they are less flexible in adapting to the particular requirements and system environments as typically encountered in this case in CGI programs. Thus, in accordance with the invention the CGI program for controlling the web interface for the radiative transfer computation is implemented in a script language of which particularly PERL, PYTHON or Tcl/Tk are particularly suitable for CGI programming. However, since a PYTHON script can be implemented independent of the method of data transmission and in addition PYTHON contains efficient numerical modules it is good practice to make use of PYTHON in the method.

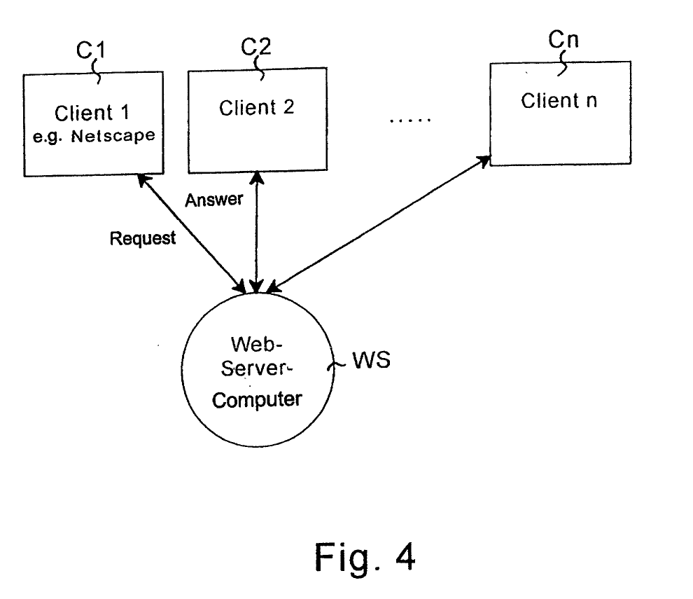

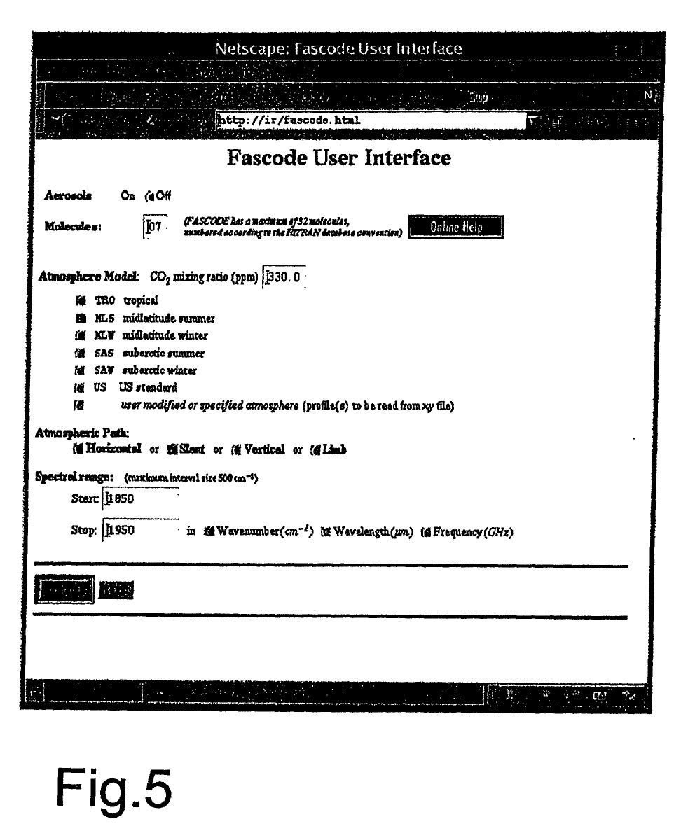

The basic principle of a CGI program is illustrated schematically in FIG. 4. Data from several client computers C1, C2, . . . , Cn are transmitted as required to a web server computer in making use of a web browser, e.g. Netscape Navigator. Once the computations have been done in the web server computer WS the results are returned as answers to the individual client computers C1, C2, . . . , Cn.

There are basically two possibilities of transmitting data from a client computer to the web server computer, namely in making use of GET requests and POST requests. Since, on the one hand, the volume of data transmittable in GET requests is limited, on the other hand, however, high volumes of data may need to be transferred, e.g. for specifying atmosphere data, it is good practice to make the transfer in accordance with the invention with the POST method: (<form action=“http://webserver/fascode.html”method=“POST”>, where the actual URL of the CGI script is indicated in the action attribute).

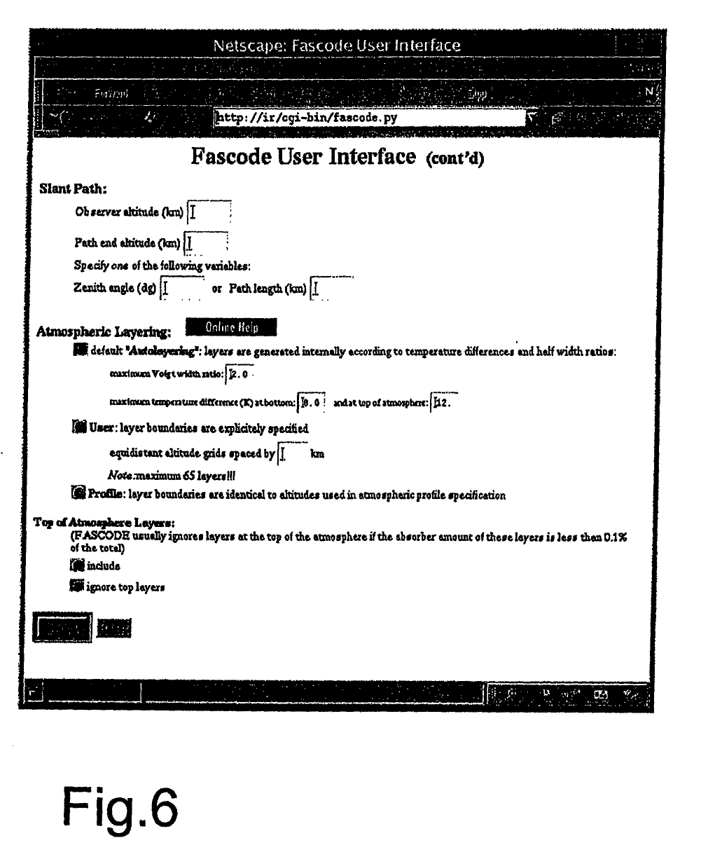

Due to the large number of inputs needed to fully specify the radiative transfer it is good practice to structure and ask the questions in several steps. In the method in accordance with the invention only a few basic inputs relevant to all radiative transfer computations need to be made on a first page, reference being made in this context to FIG. 5 illustrating the starting document page of a web interface for radiative transfer computation programs.

Further forms are automatically generated depending on the answers give by the user. If the user selects a horizontal path, for example, i.e. constant atmospheric conditions, then in the next page only the altitude of the observer location and the length of the path are asked for. Where a slant path is involved, three parameters need to be specified by the user to fully characterize the path through the atmosphere; observer altitude, Zenith angle, length or end altitude of the line of sight.

Reference is made in this context to FIG. 6 illustrating the second page of a web interface for radiative transfer computation programs. In addition, inputs are needed for all non-horizontal path configurations as to the accuracy needed in approximating the inhomogeneous atmosphere by a series of homogenous layers (Curtis-Godson).

If the user inputs are asked in a sequence of forms the answers already given need to be saved. In the method in accordance with the invention these inputs are incorporated in the automatically generating next form as a hidden input element (<input type=“hidden” name=“. . . ”value =“. . . >) but not shown by the web browser. Once the user has fully answered the next form all hidden answers are sent together with the new answers to the server computer.

Instead of assigning each form a separate CGI script all forms are processed by one and the same CGI script in the method in accordance with the invention, this being good practice since also the hidden answers need to be taken into account when processing the next form, particularly also because for safety reasons all answers, including the hidden ones, are to be basically checked for correctness. In the method in accordance with the invention the CGI script “sees” the origin of the form from an additional (<input type=“hidden” name=“origin” value=“. . . >) tag.

If the user wishes to use for the radiative transfer computation his own, e.g. measured pressure, temperature or gas concentration data instead of the model atmosphere data, this is supported in the method in accordance with the invention by the possibility of a file upload. For this purpose the users specifies the file containing his data in the form on his workplace computer and the web browser sends this file together with the remaining user inputs to the web server computer.

In the method in accordance with the invention this atmosphere data is incorporated the input file in the format as required by FASCODE or MODTRAN. The possibility of uploading the file is realized in a HTML form by an <input type=“file” name=“. . . ”> element, requiring selection of the POST method and multipart/form data as “encoding type” in the form element of the HTML document: (<form action=“. . . ” method=POST” encytpe=“multipart/form data”>)

Analogously, the user is able to transfer his own aerosol data (extinction coefficient, vertical distribution etc) via the web interface to the radiative transfer computation program.

Generating an input file for radiative transport computations is greatly facilitated by the user being presented with useful default values as best possible. This is why in the method in accordance with the invention corresponding values are preoccupied in the input element by “value” attributes (<input value=“. . . ”>) in the forms, default values being analogously set by technically known ways and means in selection menus (Radiobuttons, CheckBoxes etc).

In addition it is good practice to provide the user with indications in the configuration of the form as to what kind of input is expected and thus use is made of selection menus (Radiobuttons, CheckBoxes etc) at suitable locations in the method in accordance with the invention.

It is of assistance in processing the forms when these are displayed clearly on one side of the screen, i.e. without needing to be scrolled whilst also providing explanatory notes which are particularly important in the case of users new to the job. This is why in the method in accordance with the invention all relevant additional information exceeding the scope of a “short” form is saved on an additional HTML document, the corresponding sections being callable directly from the form by “inner” anchors.

In the method in accordance with the invention all user inputs are checked for correctness, i.e. value range of a numerical input (e.g. positive, integer number or the like), completeness and consistency. Faulty inputs are alerted to the user by a corresponding HTML document in requesting correction, supplements or the like.

Once the user has sent all inputs needed for the radiative transport computation consistently and free of error via the form to the web server, a new temporary directory is created (under UIX e.g. under /various/tmp, independent of the system with PYTHON) in the web server computer into which the FASCODE formatized input file is written; further files as necessary, e.g. the spectroscopic data base may be copied or linked to this directory and finally the radiative transfercomputation program is called by a system command. In principle, the radiative transfer computation program can be run on the web server computer or on a separate compute server.

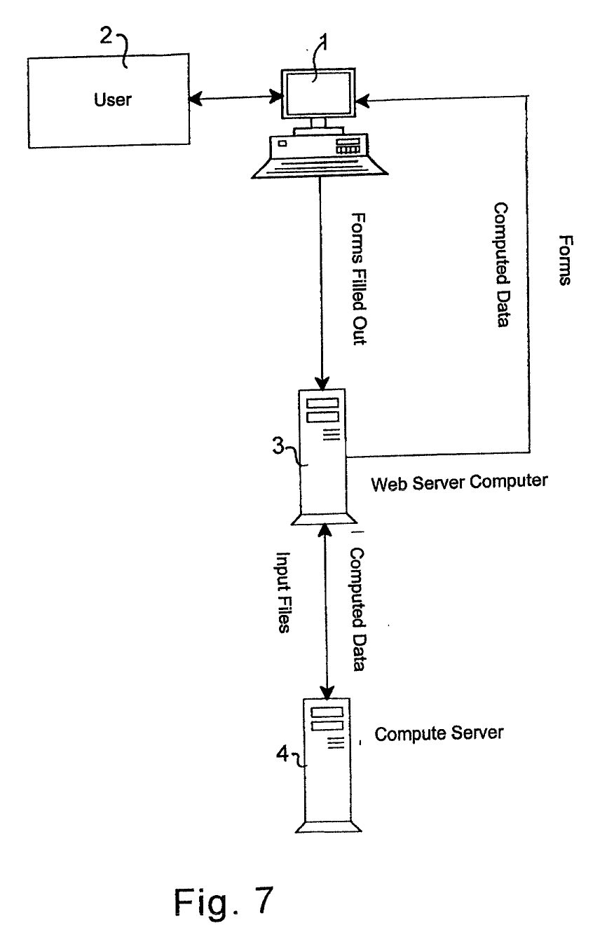

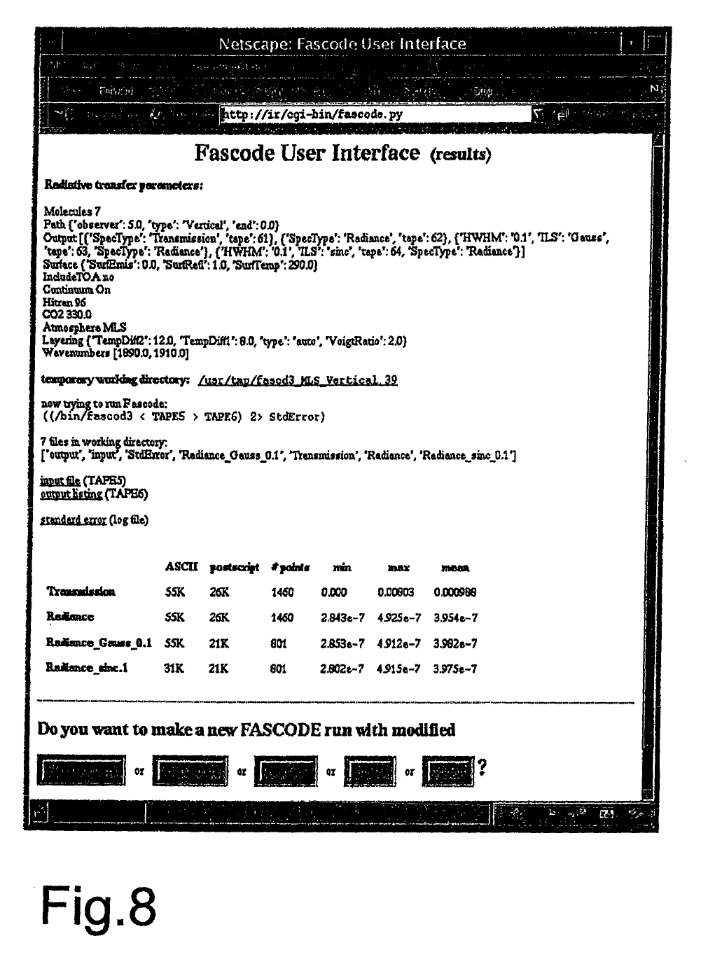

In this context reference is made to FIG. 7 in which the forms filled out by the user are sent from a workplace computer 1 of a user 2 by means of a web browser to a web server computer 3 and forms with the data computed with the aid of the radiative transfer computation program are returned to the workplace computer 1 of the user 2. The actual radiative transfer computation is executed in making use of the radiative transfer computation program either on the web server computer 3 itself or on a separate compute server computer 4, this distinction being ignored in the following for the sake of simplicity.

On completion of the radiative transfer computation the output files are suitably renamed and all temporary files removed. To assist the user, quick-look plots of the computed spectra are generated as well as the MIN/MAX and MEAN value of each spectrum determined. All of this information is grouped together in an automatically generated HTML results document. In this context reference is made to FIG. 8 showing one such results document. The user has more particularly the possibility of downloading all files on his workplace computer.

In many cases there is the necessity of implementing a series of radiative transfer computations under slightly differing conditions, e.g. for investigating the radiative transport in various spectral ranges or for investigating the influence of the observer geometry. This is why in the method in accordance with the invention it is possible on completion of the radiative transfer computation to edit a parameter or group of parameters, all other parameters in each case being taken over and transferred as hidden input elements, and to start a new radiative transport computation.

More particularly, by means of the CGI script program a sequence of FASCODE or MODTRAN computations for simulating a limb sequence or for simulating the effects of a finite field of view of a spectrometer can be automated.

Downloading the input file of a radiative transfer computation enables it to be put to use at some later date to provide all forms with default values in a new radiative transfer computation. In the method in accordance with the invention this is achieved by uploading the input file downloaded by the user in his workplace computer. As an alternative, user inputs may also be downloaded in the user workplace computer also from the web server as so-called cookies.

In standard implementation of FASCODE only a single binary spectroscopic data base may be used for the radiative transfer computation. In the method in accordance with the invention several data bases may be made use of, where necessary, by uploading user spectroscopic data from the workplace computer of the user to the web server computer, the necessary steps in preprocessing (mixing or cutting together the data bases, reformatting etc) being implemented automatically by the CGI program in the web server computer.

In standard implementation of FASCODE or MODTRAN background radiation may be taken into account in the equation (2) only in the form of a black body radiator having a given temperature (as well as and emissivity, i.e. Iₒ(ν)=εB (ν,T_{surf})+ρB(ν,Tₑₙᵥ). In the method in accordance with the invention any, e.g. measured or computed spectra I_{bg}(V) may be used as the background term of a radiative transport computation by this being uploaded from the workplace computer to the web server computer and linked to new computed transmission τ and radiance I in accordance with

I_{bg}(ν)(τ(ν)+I(ν).

What is claimed is:

1. A system for performing radiative transfer computations for which the conditions influencing the radiative transfer are specified by a user and input as parameters for executing a radiative transfer computation program comprising the steps:
handling the method via a graphical user interface by means of a common gateway interface CGI between a web browser at a user workplace computer and a web server computer,
specifying all parameters defining the radiative transfer computation in a sequence of automatically generated forms by the user on the web browser of his workplace computer,
generating the input file needed for the radiative transfer computation program in a format requested by the radiative transport computation program in the web server computer as specified by the user,
calling via a system command the radiative transfer computation program on the web server computer or, where necessary, on a separate compute server in linking any additionally required files stored in the web server computer to the radiative transfer computation program and, in conclusion
returning from said web server computer the results computed therein to said user workplace computer where they are made available on an automatically generated document.

2. The system as set forth in claim 1 wherein all output files relevant in context with the result, more particularly the computed spectra, are saved by being downloaded by the user into his workplace computer.

3. The system as set forth in claim 1 or 2 comprising use of standard HTML elements and standard CGI script programs.

4. The system as set forth in any of the preceding claims wherein additional data typically saved by the user in the form of one or more files in his workplace computer, e.g. atmosphere data, aerosol data or the like are uploaded into said web server computer and taken into account when generating the input file for the radiative transfer computation program or linked thereto when calling the radiative transfer computation program.

5. The system as set forth in any of the preceding claims wherein pre- and/or post-processing steps not representing an core component of the method, e.g. a combination of spectral data bases or taking into account a background spectrum are automatically taken over by the CGI script program.

6. The system as set forth in any of the preceding claims wherein to simplify further radiative transfer computations existing answers of the user are made use of as default values in generating the forms.

7. The system as set forth in claim 6 wherein for said purpose the input file saved in said user workplace computer is uploaded.

8. The system as set forth in claim 6 wherein for said purpose user inputs are saved as server computer cookies from said web server computer into said workplace computer.

9. The system as set forth in any of the preceding claims wherein the FASCODE, LOWTRAN or MODTRAN program is employed as the radiative transfer computation program.

10. The system as set forth in any of the claims 1 to 8 wherein it is equally applicable to other radiative transfer computation programs such as e.g. GENLN2.

11. The system as set forth in any of the preceding claims wherein the radiative transfer computation is implemented for the ultraviolet to the millimeter wave range, more particularly in the IR radiation or in neighboring spectral ranges.

12. Application of the system as set forth in any of the preceding claims in the atmospheric range.
